(19) United States
(12) Patent Application Publication
(10) Pub. No.: US 2003/0154277 A1
(43) Pub. Date: Aug. 14, 2003

(54) Method and system for real-time generating, managing, and broadcasting multimedia events reports over communications networks

(76) Inventors: Rabih Haddad, Paris (FR); Christophe De Kerviler, Meudon (FR)

Correspondence Address: Law Offices of William H. Holt, Unit 2, First Floor, 1423 Powhatan Street, Alexandria, VA, 22314, US

(21) Appl. No.: 10/071,242

(22) Filed: Feb. 11, 2002

(51) Int. Cl. G06F 15/173

(52) U.S. Cl. 709/224

(57) ABSTRACT

Method and system for generating, managing and broadcasting multimedia events reports over communications networks. The method comprises defining a model of the reports, implementing the model on a computer system, generating a user report of a current event to a user among the events by connecting a client system operated by the user to the computer system, registering an event title, date, time and place, and associating a time of the time scale with an action selected from predetermined key actions occurring during the current event in response to the user inputs by way of the user interface of the client system, storing the user report in the data storage device, and broadcasting the report over the network by way of the data communication system. The system includes a communications network and a computer system for implementing the method.

### TECHNICAL FIELD OF THE INVENTION

The present invention relates generally to computer based information distribution methods and systems, and particularly to a method and a system for real-time generating, managing, and broadcasting multimedia events reports over communications networks.

### BACKGROUND OF THE INVENTION

Nowadays dissemination of information via the Internet or other publicly accessible computer communication networks is becoming as important as newspapers or magazines.

The growth of the sector is largely supported by advertising revenues, and the success of a World Wide Web (WWW) site, mixing advertisements and information, depends widely on the matching of the kind of information offered and the preferences of the user. The more relevant information is, the greater the number of clicks and displayed advertisements is.

Search engines over the Internet enable the user to select the information she or he is looking for. In U.S. Pat. No. 5,740,549, it is proposed that information items and advertisements be each categorized so that each has an associated information category. Then the disclosed information and advertising distribution system and method use profile data stored in the user's workstation for providing a targeted audience to the advertisers.

A person interested in movies will appreciate to be informed of the latest available videos, but might be bored by ads for the brand new sporting set. Conversely, people looking for the scores of their preferred baseball team will discard any other information not related to their fields of interest.

Therefore, on-line computer services provide information to the public in a controlled, selectable manner. However, the on-line services require the use of expensive specialized equipment such as personal computers, modems, and software and require a certain level of sophistication and experience using this equipment. Additionally, using such equipment may be awkward and time-consuming in that the user needs to go to the personal computer, initialize it, log on to an on-line information service, and request the desired information.

These facts have been pointed out in international patent application WO00/33576, filed Dec. 3, 1999, by the INDEX SYSTEM Company, and entitled “System and method for providing news, sports, and local guide services through an electronic program guide”. It is disclosed an interactive TV system that combines the real-time information distribution features of an on-line information service with the ease of use, low cost, and existing broadcasting infrastructure of a television system.

On-line information, which is broadcast on the Internet, is typically stored in files that include text, hypertext, references to graphics, animation, audio, video and other electronic data. The structure of hypertext documents is defined by document markup languages such as Standard Generalized Markup Language (SGML), Hypertext Markup language (HTML), eXtensible Markup Language (XML), and others. The markup codes of the languages allows references to additional content besides text, and are the basis of multimedia documents.

Document interchange over the Internet uses a specific Transfer Control Protocol/Internet Protocol (TCP/IP). A browser implemented on a personal computer, such as Internet Explorer by Microsoft Corporation, or Netscape Navigator by Netscape Corporation, using TCP/IP to access remote servers allows the listening and/or the viewing of the multimedia content of such documents.

Other client systems than personal computers might be connected to servers via other communications networks.

In international patent application WO00/39666, filed Dec. 28, 1999, by the SPYGLASS company, and entitled “Converting content markup data for wireless devices”, it is disclosed a gateway between the Internet and a cell phone network. This gateway provides conversion facilities between HTML pages transmitted over the TCP/IP network and WPL (Wireless Markup Language) pages proceeded by a WAP (Wireless Application protocol) enabled device.

To the diversity of the types of devices, such as interactive TV sets or WAP phones, which might be connected directly or indirectly to the Internet, responds a growth of the Web broadcasting, referred to as webcasting. Webcasting is very similar to radio or television broadcasting, and audio and/or video signals are streamed continuously over the Internet using a computer system. Several software tools exist for these operations, such as NetShow Server™ developed by Microsoft Corporation, which is described in U.S. Pat. No. 6,029,200.

Existing solutions tend mainly to focus either on audio automation or on webcast automation, but not both. This has been pointed out in international patent application WO00/59227, filed Mar. 17, 2000, by the ECLECTIC RADIO Company, entitled “Apparatus and method of using the same for Internet and intranet broadcast channel creation and management”. The disclosed method utilizes a Web browser as a user interface to control the Internet or an intranet environment.

But such a tool cannot be used by the general public when, on the other hand, a continual introduction of applications and services enable individuals and organizations to conduct more and more elaborate interchanges of information over the Internet in an automated way.

For example, international patent application WO00/77709, filed Jun. 13, 2000, by the INTEGRAL DEVELOPMENT Corporation, relates to an interactive and automated Web-based system and method for conducting financial transactions and managing portfolios and related financial information in capital markets. Automated communications enabling connectivity with user systems are facilitated using XML-based syntax and XSL-based programming language.

International, national and local news, financial market news, sports results, and entertainment guides are among the most popular items of information. Information related to sporting events is perhaps of the greatest of interest to the public, as in many countries lotteries in conjunction with sports results are commonplace. A lottery of this kind is, for example, described in U.S. Pat. No. 6,015,345.

What is needed therefore is a method and a system for real-time generating, managing, and broadcasting multimedia events reports over communications networks which overcomes the limitations of the existing methods and systems, and is especially adapted to sporting events.

### SUMMARY OF THE INVENTION

In a principal aspect, the method for generating, managing, and broadcasting multimedia events reports over communications networks of the present invention is based on a few specific steps:

a first step of defining a model of relevant multimedia events reports having at least an event model with building blocks including a representative set of pre-determined categories of these events, a set of pre-determined key actions for each of the pre-determined categories, and a pre-determined time scale of pre-determined key actions.

a second step of implementing this model on a computer system having at least data input means, data output means, data processing means, data storage means, and data communication means connected to at least a first network using at least a first protocol.

a third step of generating a user report of a current event of particular interest to a user by connecting at least a first client system operated by the user to the computer system via at least the first network, selecting a current category among pre-determined categories which best fits the current event according to the user's choice, registering an event title, an event date, an event time and an event place as a title, a date, a time and a place of current event respectively, and associating a first current time of the time scale with a current action selected among the pre-determined key actions occurring during current event in response to first user inputs by means of the user interface of the first client system.

a fourth step of storing the user report in the data storage means.

a fifth step of broadcasting the user report over at least the first network by means of the data communication means.

In accordance with further aspects of the invention, the first step of the method includes:

defining a description model of the events with building blocks including a set of predetermined items for each of the pre-determined categories.

defining a scoring model of the events with building blocks including a set of predetermined outcomes for each of the pre-determined categories.

defining a statistics model of the events with building blocks including a set of pre-determined sortings for each of the pre-determined categories.

The building blocks of the model advantageously include a pre-determined newsflash type for each of the pre-determined categories, and the third step of the method of the present invention further includes registering of a current newsflash of current newsfiash type corresponding to current category associated with a second current time of the time scale in response to second user inputs by means of the user interface of the first client system.

According to the invention the building blocks of the event model further include a set of pre-determined medias for each of the predetermined categories, and the third step of the method further includes loading a current media file of current media type selected among the predetermined medias corresponding to current category, and associated with the current newsflash, in response to third user inputs by means of the user interface of the first client system. An icon is preferably associated with the current media file.

The method of the present invention advantageously benefits from a current media file content that is a streaming multimedia content.

In accordance with still further aspects of the invention, the second step includes declaration of the building blocks of the event, description, scoring and statistics models according to the rules of a standard computer language, preferably compliant with XML Schemas standard.

Advantageously, the first network to which are connected the data communication means used by the invention is a data transport network, preferably the Internet, and the first protocol is preferably TCP/IP (Transport Control Protocol/Internet Protocol).

Data communication means are also connected to at least a second communications network using at least a second protocol, this second network being preferably a cell phone network and that second protocol being preferably a Wireless Application Protocol (WAP).

Advantageously, the second network and the second protocol are used by the user to update, as well as to broadcast, her/his report.

Data communication means are further connected to at least a third network, preferably an interactive television network, for updating and broadcasting the user's reports.

In accordance with more specific aspects of the method, relevant events are sporting events and the set of pre-determined categories includes basket-ball, bowling, european football or soccer, american football, formula 1, handball, ice hockey, judo, rugby, tennis, volley-ball, and other sports.

For each of these pre-determined categories, the set of pre-determined items includes player, team, referee, category of player, sex, level of competition. Preferably, the set of predetermined outcomes and of pre-determined sortings for each of the pre-determined categories comprises scores, results, standings, and sorting by player, sorting by team, sorting on the event, respectively.

When the current category among pre-determined categories is soccer, pre-determined time scale comprises preferably first half second half, first extra, second extra and added time, and the set of pre-determined key actions includes clearance, corner, direct free kick, end of game, extra time, foul, free kick, goal, goalkeeper, save, hand ball, indirect free kick, injury, offside, own goal, penalty, red card, shoot on goal, shoot outside goal, start of the game, stoppage, substitution, touch, yellowcard.

In accordance with a still further feature of the invention, the third step of the method includes associating a current action icon selected among a set of pre-determined key action icons with said current action in response to said first user inputs.

In another principal aspect, the present invention provides a system for real-time generating, managing, and broadcasting multimedia events reports over communications networks comprising:

a first network.

a computer system having at least an applications server, a data base management system, and a communications server connected to the first network.

at least a first client system connected to the computer system via at least the first network having at least a graphical user interface and a communication software, display means, pointing means and typing means, wherein this interface includes:

a first drop-down list of pre-determined categories of events for selecting a current category.

a first entry field for entering an event title.

a second, third and fourth drop-down list of respectively days, months and years for selecting the event date.

a fifth, sixth and seventh drop-down list of hours, minutes and time area for selecting the event time.

a eighth drop-down list of countries for selecting the event country.

a second entry field for entering the event city.

a ninth drop-down list of pre-determined key actions for selecting the event current action.

a third entry field for entering the current time of current action.

first command buttons for validating first user entries upon user commands and transferring these first entries to the communications server using the communication software.

In accordance with the invention, the applications server further processes these first and second entries for generating and broadcasting a user report according to data stored in the data base over at least the first network by means of the communications server.

Advantageously, the graphical user interface further includes:

a fourth entry field for entering a title of a newsflash associated with current time or current action.

a first multi-line text box for entering a comment associated with the newsflash title.

a tenth drop-down list box for selecting a media type associated with the newsflash title.

a first file open dialog for selecting a media file of said media type associated with the newsflash title.

a second file open dialog for selecting an icon associated with the media file.

second command buttons for validating second user entries upon user commands and transferring said second entries to the computer system using the communication software.

In accordance with still further aspects of the invention, the system comprises a second communications network, this second network being preferably a cell phone network. In this case, the user interface advantageously includes first option buttons for broadcasting, or not, user's report over the second network.

Preferably, the interface also features second option buttons for updating at least first and second entries by means of a second client using a Wireless Application Protocol (WAP).

Embodiments employing the principles of the present invention benefit from a computer system wherein:

the first network is a network using the TCP/IP protocol, preferably the Internet.

the communications server comprises at least a first HTTP server.

the communication software is an Internet browser.

In this case, the first HTTP server submits the pages received from the browser to the application server further comprising servlets components, preferably according to the Java Server Page™ (JSP) standard, for real-time generating dynamic web pages of events reports. The content of these pages is compliant with a XML description stored in the database of the computer system, preferably in XML Schema Description files.

According to other aspects of the invention:

the communications server further comprises at least a second HTTP server.

the computer system further comprises a peer to peer server connected to the first network via the second HTTP server.

Then the media file associated with a newsflash by the user is advantageously uploaded or downloaded on that peer to peer server

As a result of these specifications, the user report generated by the system features a plurality of lines; each line comprising a current time and a current action icon automatically associated with the current action.

The user report also features a plurality of paragraphs, each paragraph comprising a current time and associated newsflash. A paragraph further includes an icon associated with a media file or the image of a media file, according to its media type.

The above and other aspects, features, and advantages of the invention will be better understood by reading the following more particular description.

### BRIEF DESCRIPTION OF THE DRAWINGS

In the course of this description, reference will be made to the attached drawings, wherein:

FIG. 1 shows a flowchart of the method for real-time generating, managing, and broadcasting multimedia events reports over communications network according to the present invention.

FIG. 2 shows details of the first step of the method of the present invention.

FIG. 3 shows details of the third step of the method of the present invention.

FIG. 4 shows details of the fifth step of the method of the present invention.

FIG. 5 shows a XML declaration of event model building blocks in an embodiment of the present invention for soccer events.

FIG. 6 shows a XML declaration of event model building blocks in an embodiment of the present invention for judo events.

FIG. 7 shows a XML declaration of description model building blocks in an embodiment of the present invention for soccer events.

FIG. 8 shows a XML declaration of description model building blocks in an embodiment of the present invention for judo events.

FIG. 9 shows a XML declaration of description model building blocks in an embodiment of the present invention for tennis events.

FIG. 10 shows a XML declaration of scoring model building blocks in an embodiment of the present invention for soccer events.

FIG. 11 shows a XML declaration of scoring model building blocks in an embodiment of the present invention for judo events.

FIG. 12 shows a XML declaration of statistics model building blocks in an embodiment of the present invention for soccer events.

FIG. 13 shows the general architecture of an embodiment of the system for real-time generating, managing, and broadcasting multimedia events reports over communications networks according to the present invention.

FIG. 14 shows an architectural overview of an embodiment of the system for real-time generating, managing, and broadcasting multimedia events reports over communications networks according to the present invention.

FIG. 15 shows a representation of a partial screen capture of an embodiment of the client system graphical interface according to the present invention showing user entries for creating an event report.

FIG. 16 shows a representation of a partial screen capture of an embodiment of the client system graphical interface according to the present invention showing first user entries for configuring a soccer event report.

FIG. 17 shows a representation of a partial screen capture of an embodiment of the client system graphical interface according to the present invention showing second user entries for configuring a soccer event report.

FIG. 18 shows a representation of a partial screen capture of an embodiment of the client system graphical interface according to the present invention showing user entries for feeding a soccer event report.

FIG. 19 shows a representation of a partial screen capture of an embodiment of the client system graphical interface according to the present invention showing user entries for configuring a judo event report.

FIG. 20 shows a representation of a partial screen capture of an embodiment of the client system graphical interface according to the present invention showing first user entries for feeding a judo event report.

FIG. 21 shows a representation of a partial screen capture of an embodiment of the client system graphical interface according to the present invention showing second user entries for feeding a judo event report.

FIG. 22 shows a representation of a partial screen capture of an embodiment of the client system graphical interface according to the present invention showing user entries for configuring a tennis event report.

FIG. 23 shows a representation of a partial screen capture of an embodiment of the client system graphical interface according to the present invention showing first user entries for feeding a tennis event report.

FIG. 24 shows a representation of a partial screen capture of an embodiment of the client system graphical interface according to the present invention showing second user entries for feeding a tennis event report.

FIG. 25 shows a representation of an HTML page of a soccer event report broadcast over the Internet by an embodiment of the computer system according to the present invention.

FIG. 26 shows a representation of an HTML page of a judo event report broadcast over the Internet by an embodiment of the computer system according to the present invention.

FIG. 27 shows a representation of an HTML page of a tennis event report broadcast over the Internet by an embodiment of the computer system according to the present invention.

### DESCRIPTION OF THE PREFERRED EMBODIMENTS

Preferred embodiments of the present invention are now described with reference to the Figures, where like reference numbers indicate identical or functionally similar elements. Also in the Figures, the left most digit of each reference number corresponds to the Figure in which the reference number is first used.

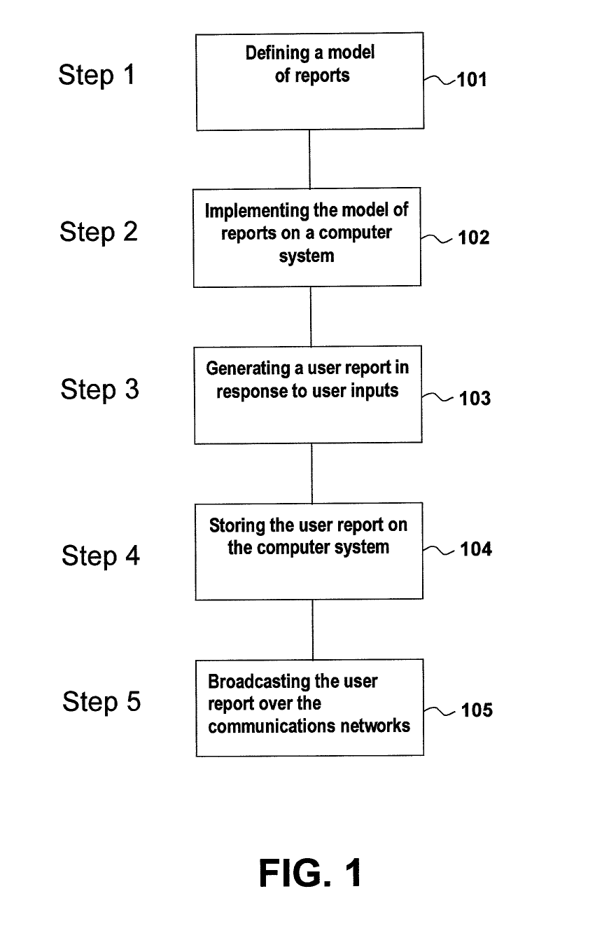

Referring now to FIG. 1 of the drawings, there is shown how the method for real-time generating, managing, and broadcasting multimedia events reports over communication networks proceeds though a series of steps.

In the first step 101 a model of reports is defined. This model is implemented on a computer system in a second step 102. When a user wants to create a report, she/he enters the system and submits data describing the event according to the pre-determined scheme allowed by the model. The user inputs are processed by the computer system and a specific report is generated 103. Next 104, the report is stored on the computer system before being broadcast over the communications networks in the last step 105.

In order to be easily translated in a structured computer language, the model is precisely defined in the first step 101 of the method of FIG. 1.

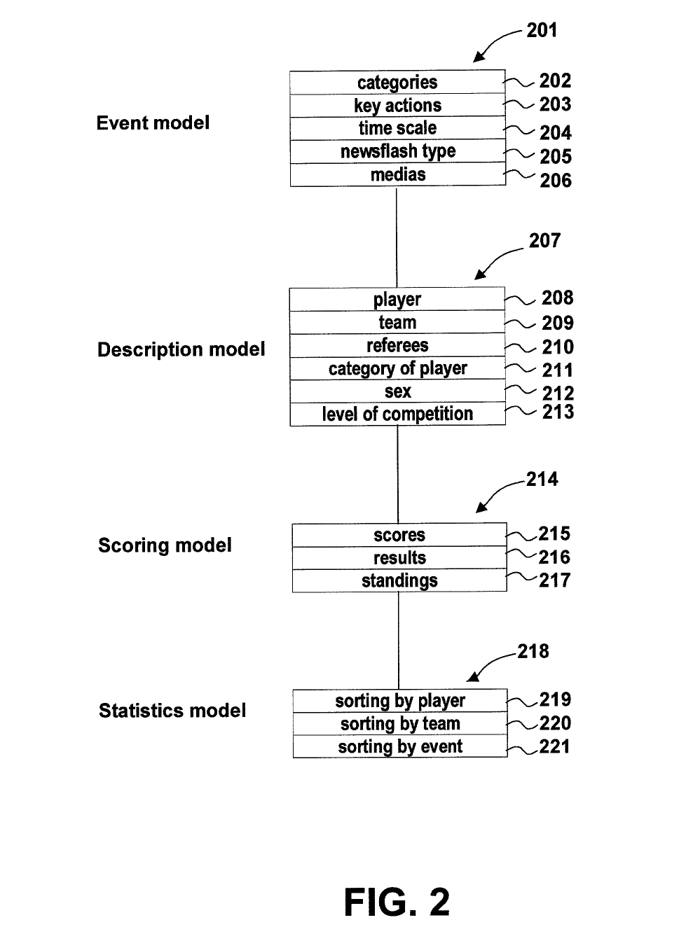

FIG. 2 illustrates the detailed structure of the model. It comprises:

an event model 201

a description model 207

a scoring model 214

a statistics model 218

The model of the preferred embodiments is mainly adapted to sporting events, such as basket-ball, bowling, european football or soccer, american football, formula 1, handball, ice hockey, judo, rugby, tennis, volley-ball, and other sports. However, other models might be designed for other kinds of events, such as cultural events.

The categories of sporting events listed above are values of the main entity 202 of the event model 201 which constraint the values of others entities, such as “key actions” 203, or “time scale” 204. For example, if the value of the “categories” entity 202 is “soccer”, values of the “key actions” entity 203 might only be selected among a set of pre-determined key actions with comprises: clearance, corner, direct free kick, end of game, extra time, foul, free kick, goal, goalkeeper, save, hand ball, indirect free kick, injury, offside, own goal, penalty, red card, shoot on goal, shoot outside goal, start of the game, stoppage, substation, touch, yellowcard. In the same case, the pre-determined set of values of the “time scale” entity 204 comprises: first halt second half, first extra, second extra and added time. Key actions 203 and time scales 204 are obviously different for reports about tennis or judo.

The common newsflash type 205 comprises a current time of the time scale 204 and the associated text. A multimedia content can also be associated with the current time. It might be a picture, an audio file or a video. These are the allowable values of the “medias” entity 206 of the event model 201.

Another important part of the model is the description model 207. A sporting event is described by six entities:

player 208

team 209

referees 210

category of player 211

sex of player 212

level of competition 213

Outcomes of games are also very important to the public, therefore the model comprises a scoring model 214, for modelizing scores 215, results 216 and standings 217.

The model further features a statistics model 218 comprising three entities: sorting by player 219, sorting by team 220, sorting by event 221. The values of these entities enable the user to select information about her/his favourite player(s) or team(s), or to sort a particular kind of event respectively.

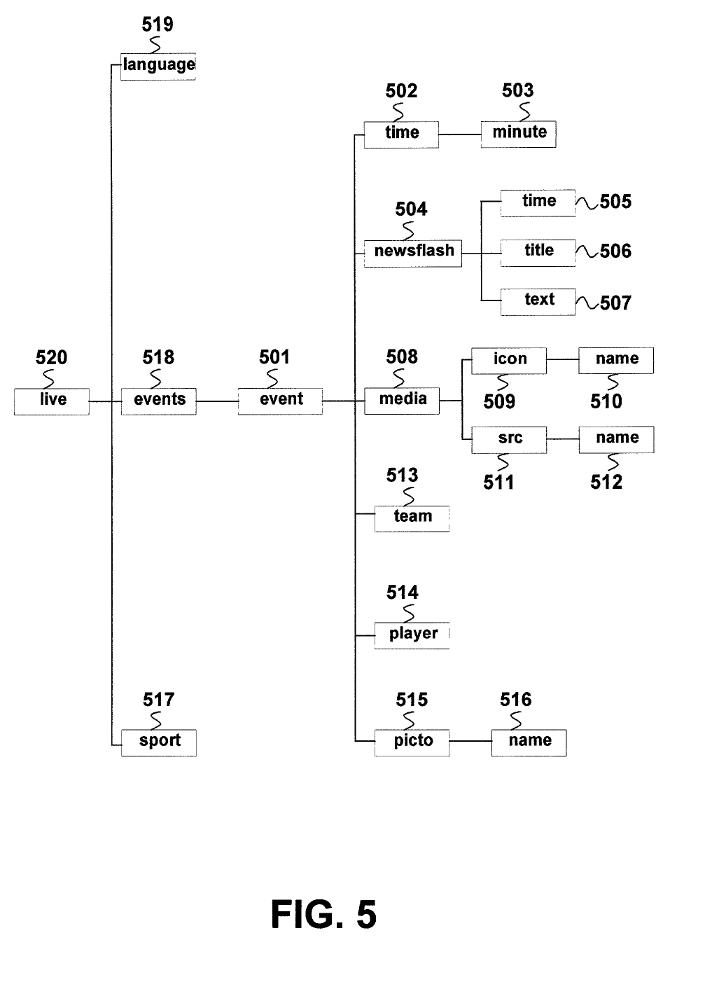

In the second step 102 of the method, the model is encoded in XML (Extensible Markup Language). FIGS. 5 to 12 show sample declarations of the building blocks which will be discussed later. These declarations are stored in XML Schema Description files in the computer system, and they are used to automatically generate a report in response to user inputs in the third step 103.

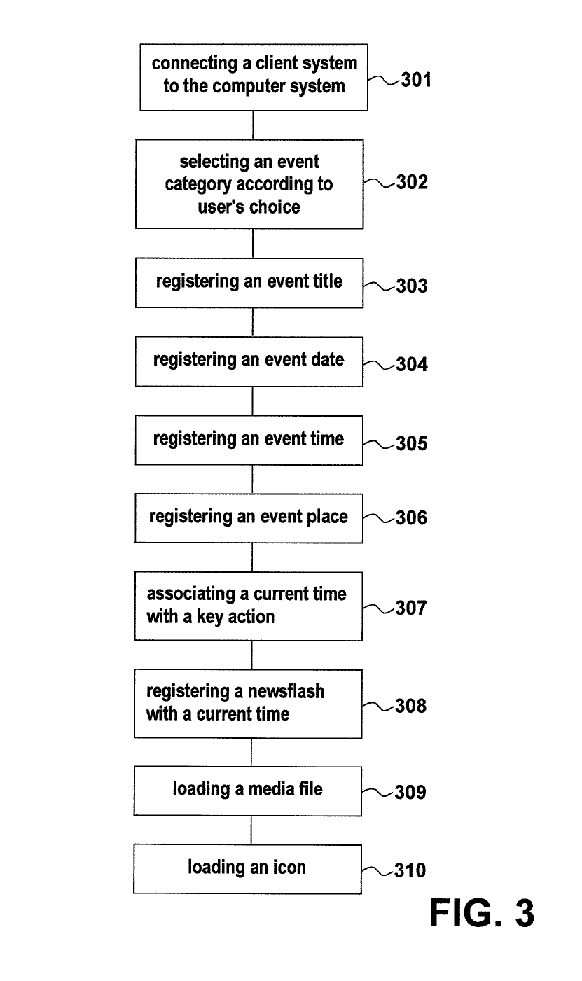

The flowchart of FIG. 3 shows how a user can very easily create and update a multimedia report of an event of her/his choice without any programming, and with very little typing.

First, the computer system establishes a connection with a client system (item 301). A client system is for example the personal computer of a user who engages a transaction with a WWW site having implemented the method of the present invention for providing means for real-time generating, managing, and broadcasting sports reports through the Internet. An event category is selected by the computer system of the Web site when it receives the user's choice transmitted by the user's browser (item 302). The system registers an event title (item 303), an event date (item 304), an event time (item 305), and an event place (item 306) sent by the user when she/he creates the report. Then each time something interesting happens, the user transmits the current time and information about what is happening. The user may choose one of the pre-determined key actions according to the selected category of event, thus the computer system is able to associate a key action with a current time (item 307) of the time scale, or the user may prefer to write a newsflash, which will be also associated with the current time (item 308). A media file can be uploaded (item 309) by the user as part of the newsflash for illustrating the report. An icon pointing to this file can be uploaded as well (item 301).

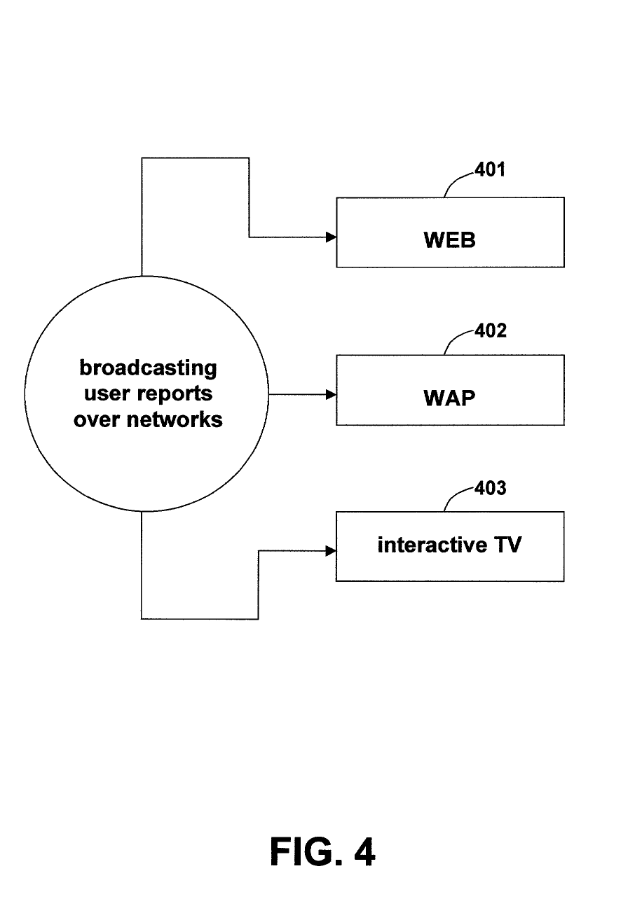

Reports are basically broadcast on the Internet. However, FIG. 4 shows schematically that reports can be broadcast over other communications networks than the Internet 401, such as interactive TV networks 403, or mobile telephone networks 402.

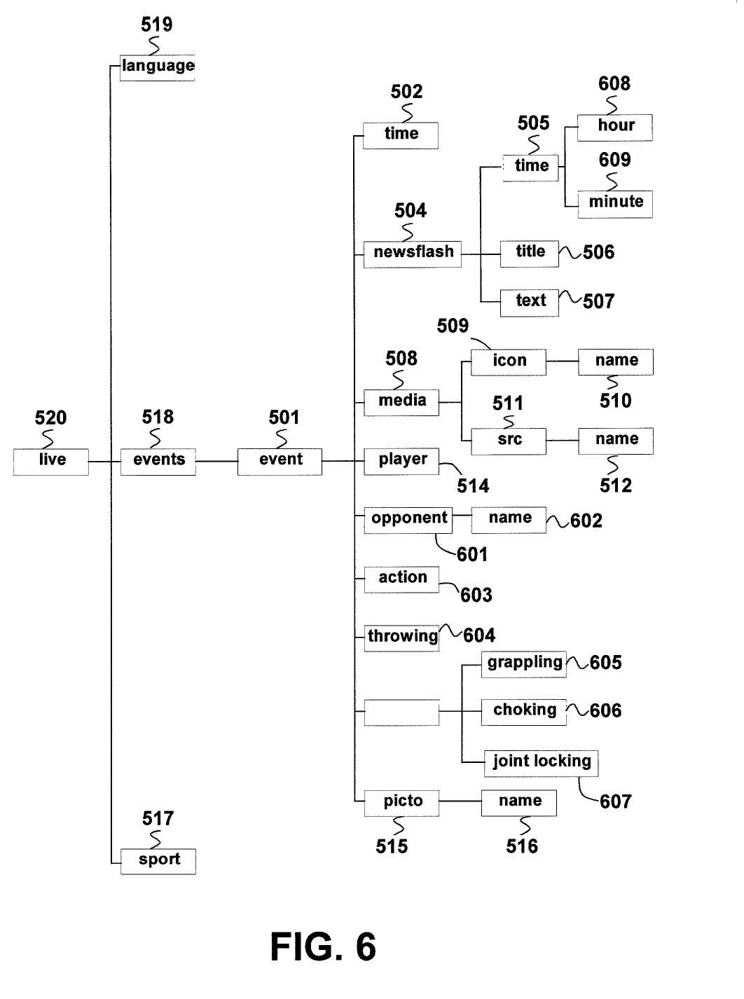

As it has already been pointed out, the method of the present invention uses XML to encode the objects of the models. FIGS. 5 to 12 are a few printouts of XML Schema Description files edited by means of the XML Spy™ 3.5 software implemented on a workstation of the development workshop. FIG. 5 and FIG. 6 illustrate the computer implementation of the event model 201 for soccer and judo, respectively.

“Event” element 501 contains sub-elements of the type already described with reference to FIG. 2:

time 502, such as first half, and minute 503 corresponding to the “time scale” entity 204 for soccer

newsflash 504, including time 505, title 506, and text 507 corresponding to the “newsflash type” entity 205

media 508, including an icon 509 and its name 510, as well the source record 511 and its name 512, corresponding to the “medias” entity 206.

team 513, player 514, pictogram 515, and name 516 corresponding to the “key actions” entity 203.

The main feature of the method of the present invention is to allow very easily association of values of the “Key actions” entity 203 with values of the “Time scale” entity 204. For example the goal pictogram 515 and its legend 516 will be associated with the name of the successful player, the name of the team, and the 12 th minute 503 of the first half 502.

All the “event” elements 501 are members of an “events” set 518, and are labelled by the name of the sport 517, or, more generally speaking, by a value of the “categories” entity 202.

To allow localization, i.e. translation of the model into several languages according to the countries where users are coming from, the “event” element 501 also depends on the “language” leaf 519.

The root 520 of the tree is a meta-object called “live”, as this structure enable any user to author live broadcasts.

FIG. 6 illustrates a structure in the case of judo, which is basically the same as the structure of FIG. 5. Instead of the “team” element 513, an “opponent” element 514 and the “name” element 602 are used. Action 603, and several important key actions 203 are explicit, such as throwing 604, grappling 605, choking 606, and joint locking 607.

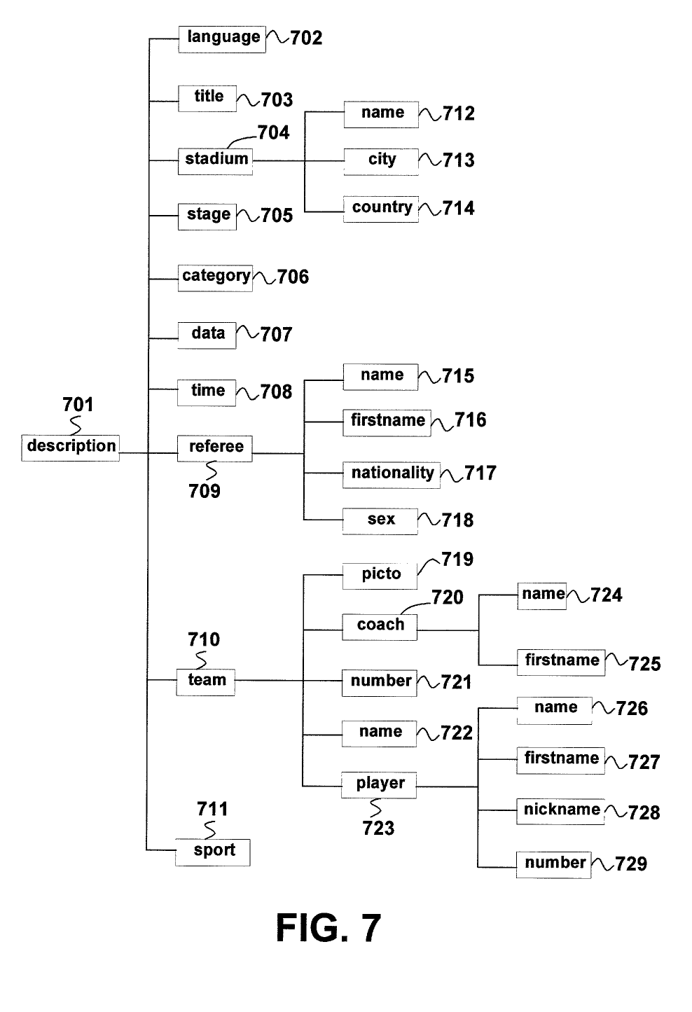

Referring now to FIG. 7, 8 and 9, there are shown sample computer printouts of the description model 207 for soccer, judo, and tennis events, respectively.

The tree structures of FIG. 7, 8 and 9 implement in these particular cases the entities of the description model 207 described with reference to FIG. 2. The “language” element 702 and the “sport” element 711 are standard leaves connected directly to the “description” root 701, as well as the “title” element 703, the “stage” element 705, the “date” element 707, and the “time” element 708.

For judo or tennis events, sex of competitors determines the category of the match, thus the “sex” element 801 appears at this first level.

For tennis, the “match” 906, “sets” 907, and “tiebreak” 908 elements corresponding respectively to the kind of match (Singles, doubles, men, women, mixed) and to such important information as sets and tiebreak are also linked directly to the root 701.

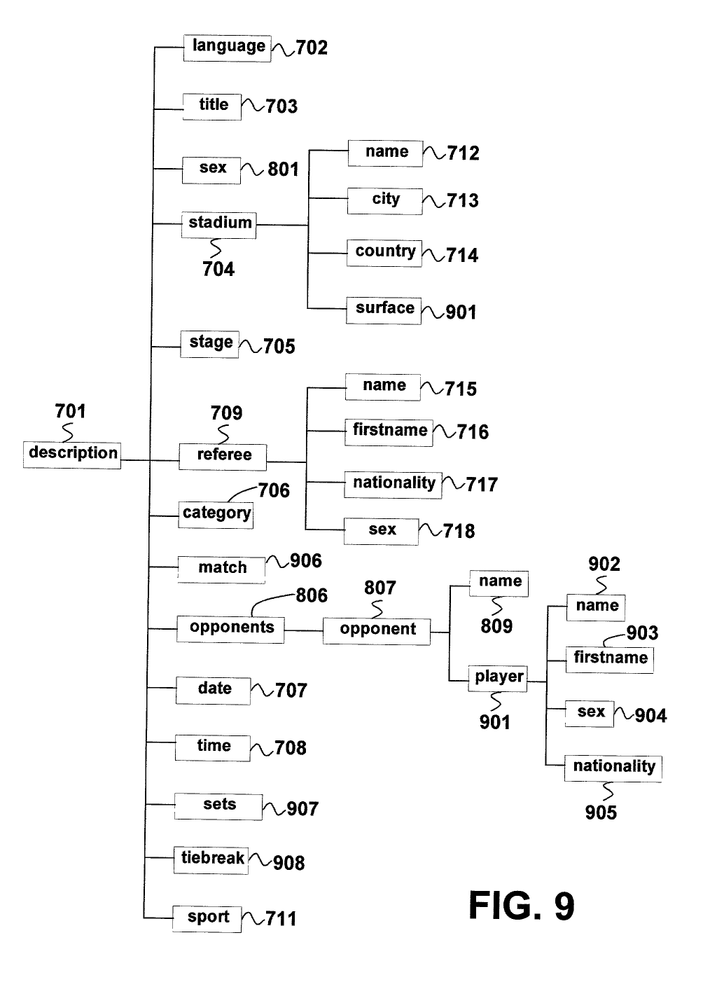

The set of leaves connected to the “stadium” branch 704, depends on the sport. Besides name 712, city 713, and country 714, there is a “surface” leaf 901 for tennis events (FIG. 9), as the kind of surface is very important for tennis matches.

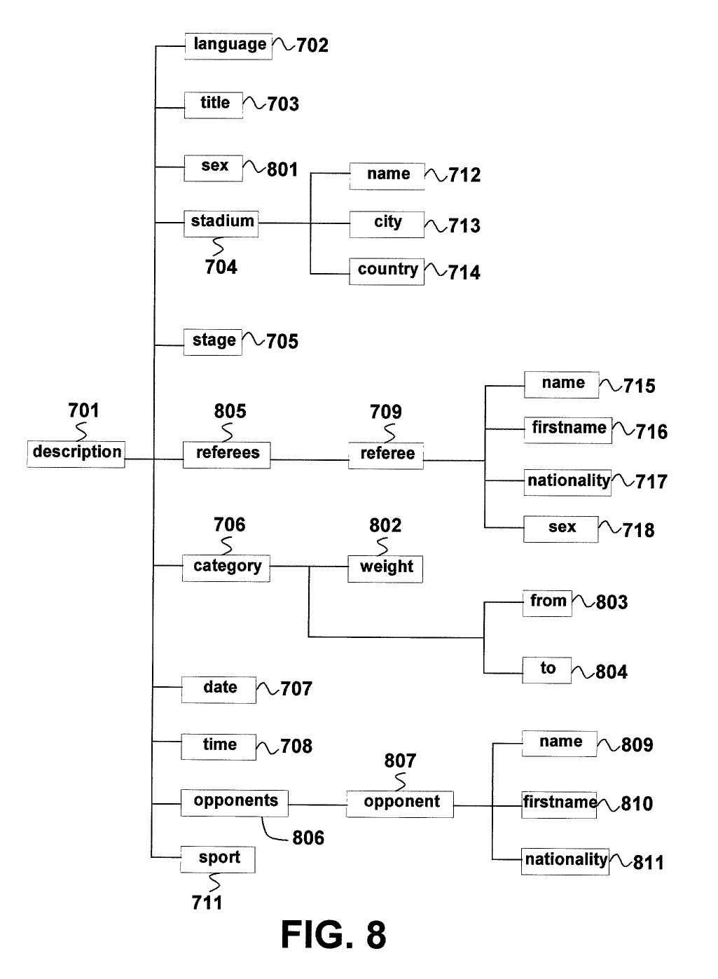

The “category” element 706 is either a leaf as for soccer (FIG. 7) or tennis (FIG9), or a branch, as for judo (FIG. 8), as further details about the weights 802, or category of weight 803, 804 of the competitors are needed.

The “referee” entity 210 is either a single or multi-value entity as there is only one referee for soccer games or tennis matches, but there are one referee and several judges for a judo event. Therefore, the “referee” branch 709 extends a “referees” branch 805 in the case of judo (FIG. 8). Name 715, firstname 716, nationality 717, and sex 718 are of course the standard attributes of the “referee” entity 210.

The last entities to consider are “player” 207 and/or “team” 208.

In the case of soccer event (FIG. 7), the corresponding branch 710 is rather complicated. A team 710 has a number 721, a name 722, and a color 719, and comprises a coach 720 and players 723. The name of the coach 724, and his first name 725 may be entered in the model. A player 723 is known by his name 726, his firstname 727, his nickname 728, and his number 729.

In the case of judo (FIG. 8) or tennis events (FIG. 9), the “opponents” 806 or “opponent” 807 elements are a bit simpler. For judo, only the name 809, the first name 810, and the nationality 811 are requested. For tennis matches, the model distinguishes between the name 809 of the opponent 806, 807, and the name 902 of a player 901, who is further identified by firstname 903, sex 904, and nationality 905.

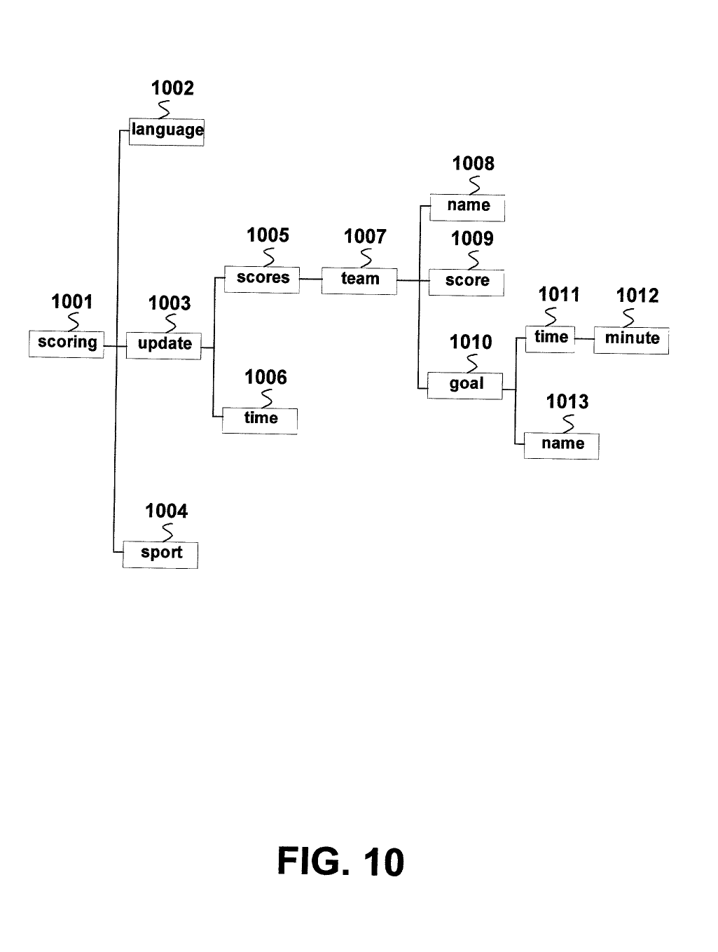

Referring now to FIG. 10, and 11, there are shown sample computer printouts of the scoring model 214 for soccer, and judo events, respectively.

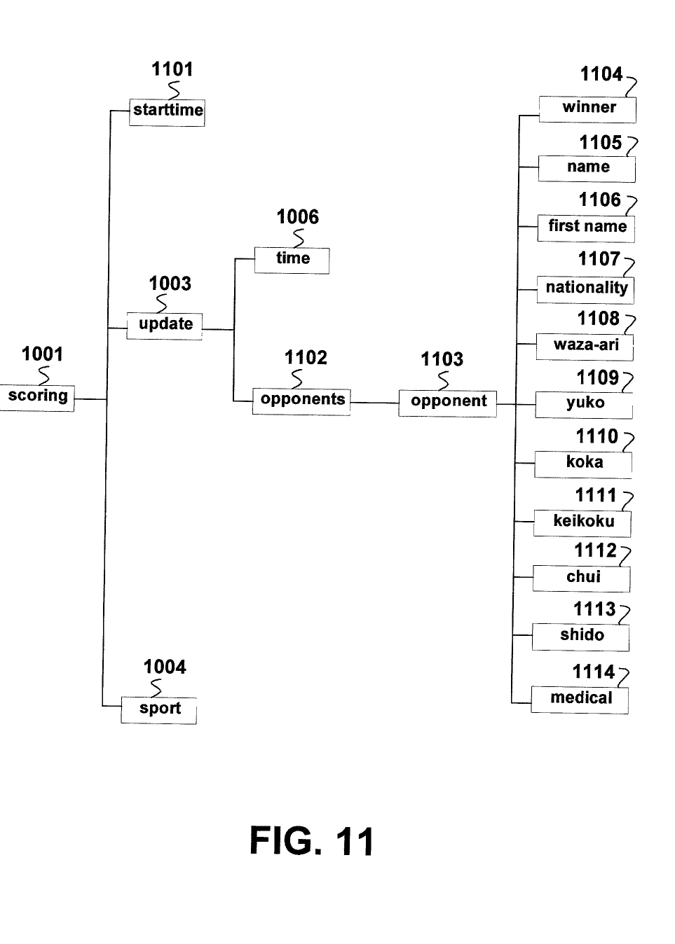

The tree structures implement in these particular cases the entities of the scoring model 214 described with reference to FIG. 2. The “language” element 1002 and the “sport” element 1004 are standard leaves connected directly to the “scoring” root 1001, The main “update” branch 1003 bears a “time” leaf 1006 and either “scores” 1005 and “team” 1007 branches in the case of soccer (FIG. 10), or “opponents” 1102 and opponent” 1103 branches in the case of judo (FIG. 11).

As usual during soccer contests, the name 1008 of the scoring team 1007 is associated with the new score 1009, the time 1011 and minute 1012 of the action, and the name 1013 of the player who scores the goal 1010.

In the case of judo events, pertinent information is of course the name 1105, firstname 1106, and nationality 1107 of the winner 1104, as well as the detailed elements of the scoring: waza-ari 1108, yuko 1109, koka 1110, keikoku 1111, chui 1112, shido 1113, medical 1114.

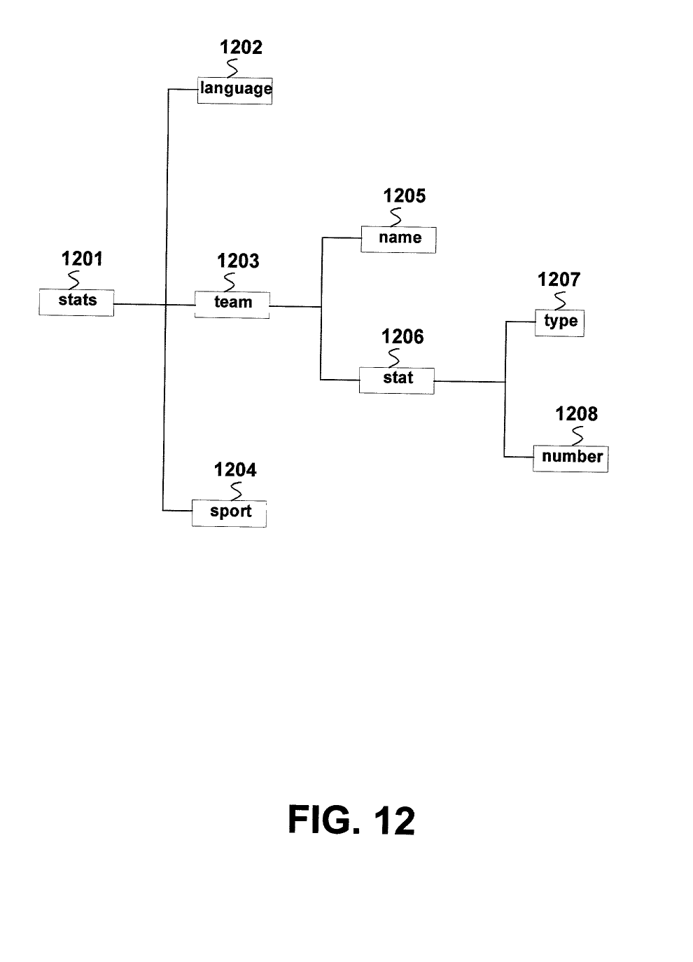

Only one example of the XML implementation of the statistics model 218 will be given with reference to FIG. 12: the case of soccer games. The last building block 218 of the event model is implemented in the same way as the other ones. A “stats” root 1201 bears directly a “language” leaf 1202 for localization purposes, and a “sport” leaf 1204 to enable sorting by event. The main “team” branch 1203 bearing a “name” leaf 1205 allows the sorting by the name of the team. The “number” element 1208 stores the results of the different kinds of sortings according to the value of the “type” element 1207.

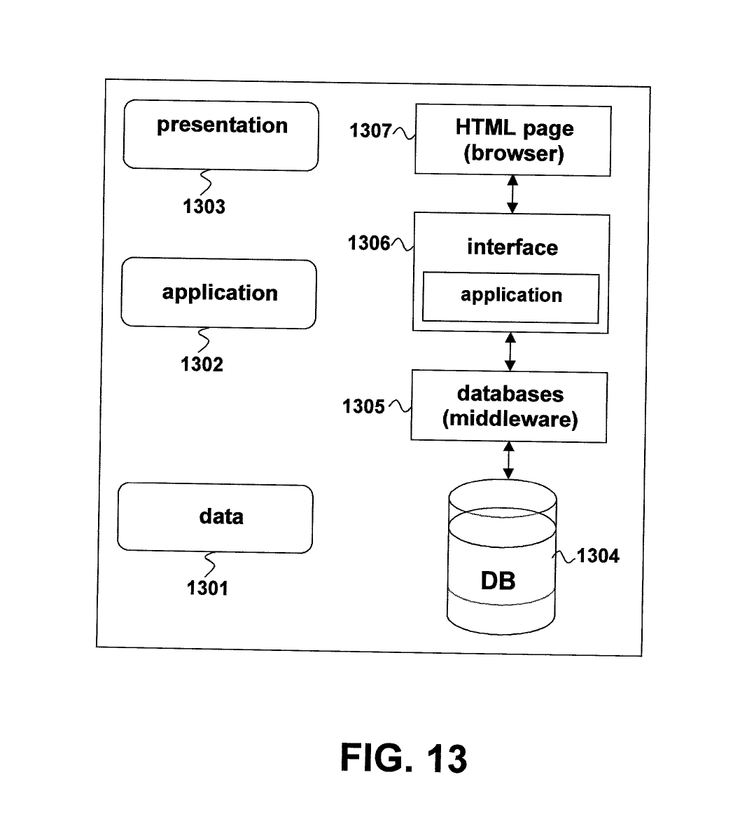

Referring now to FIG. 13, there is shown the general architecture of the preferred embodiment of a system for implementing the method for real-time generating, managing, and broadcasting multimedia events reports over communication networks described above.

This architecture features three layers:

a data layer 1301

an application layer 1302

a presentation layer 1303

The data layer 1301 comprises the databases 1304 and the database management software (middleware 1305) which are necessary to store and to retrieve all the data of the system.

The presentation layer 1303 presents to the user the data which have been retrieved from the data layer 1301 and processed by the application layer 1302, and conversely submits to the application layer 1302 the user's data to be stored in the data layer 1301. HTML pages displayed by the browser 1307 of the user's workstation are the standard tools used to communicate with the interface 1306 of the computer system via the Internet.

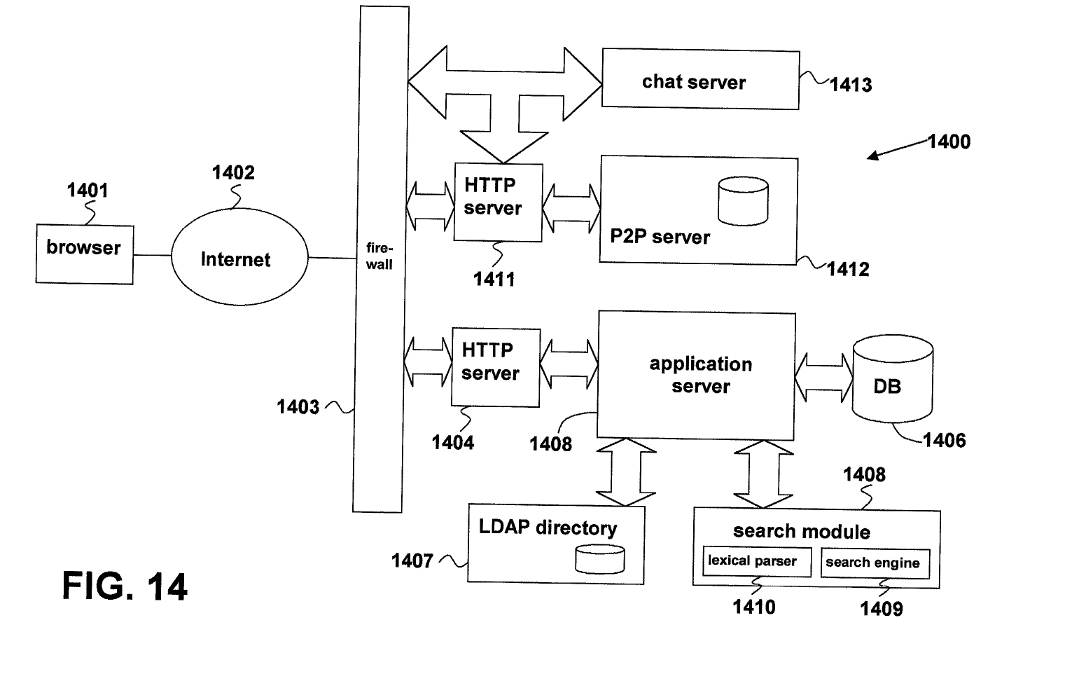

The operation of the system will now be described with reference to FIG. 14.

Though only one browser 1401 running on a user's workstation is shown on FIG. 14 for simplicity, there could also be multiple client systems situated in multiple locations and connected to the Internet 1402.Any browser 1401 such as Internet Explorer 5, Netscape Communicator or Netscape 6 is supported by the computer system 1400.

The computer system 1400 is connected to the Internet 1402 by means of a firewall 1403 in order to protect the hardware and the software of the web site.

A first HTTP server 1404 receives the requests emitted by user's browser 1401 and submits them to a servlet engine of the application server 1405. An Enterprise 250™ bi-processor central unit from Sun Corporation with a 1 GB central memory and a 36 GB mirrored disk space running Apache V1.3.14 HTTP server open source is dedicated to this task.

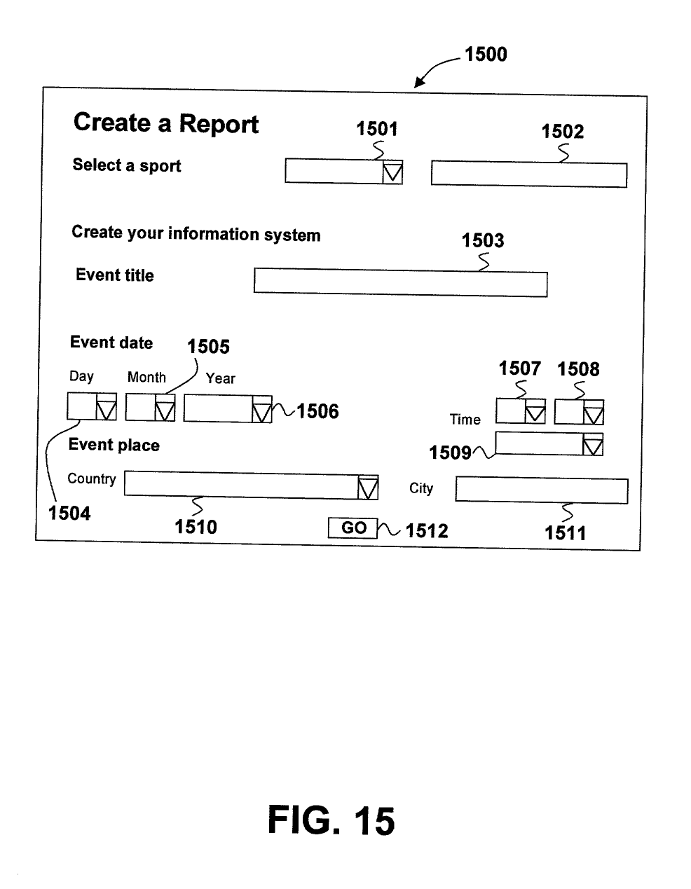

The application server 1405 is architectured around the servlet engine. Real-time generation of the HTML pages sent to the user's browser 1401 is achieved by means of the Java™ Application Programming Interface (API) invoking Java Server Page™ (JSP) components, and allowing access to the database 1406 with a JDBC implementation. The XML representations of the reports models stored in the database 1406 are combined with Java™ code within the JSP components for producing dynamic HTML pages such as the screen captures of which representations are shown by FIGS. 15 to 27.

The application server 1405 is also a bi-processor Sun® Enterprise 250™ with 1 GB of central memory and 36 GB of hard disk. The machine runs the Tomcat™ 3.2 server engine, Java™ 1.3.1 and Cocoon™ 1.8 for the real-time generation of the HTML pages from the XML documents.

The database 1406 allows the persistency of the data used by the application server 1405. This database 1406 is mainly the support of the contents of the reports, and of the components of the applications. The DBMS is Oracle® 8i running on a Sun® Enterprise 420™ with a 2 GB central memory and a 36 GB mirrored disk space.

The LDAP directory 1407 is an optional component. It manages logons and passwords of users accessing the site. It is implemented on the same machine as the database 1406.

The search module 1408 comprises a search engine 1409 allowing queries in natural language 1410 for retrieving information on the web site. It runs on the same machine as the application server 1405.

The computer system 1400 comprises advantageously a second HTTP server 1411 allowing the user to download/upload media files from/to a peer-to-peer server 1412. Another optional component comprises a chat server 1413.

The computer system 1400 described above is a production platform offering a large disposability to the user. A development platform comprising 3 to 10 workstations has been used for the development of the first version of the software, and allows continuous improvements by the addition of new sports models. The workstations are personal computers of the Pentium® III type running XML Spy™ 3.5 for XML modelization, and Jbuilder™ 4 for Java™ developments. A simulation of the production platform is build around a Sun® U10 running Apache 1.3.14, Tomcat™ 3.2, and Cocoon™ 1.8 as the HTTP server 1404 and the application server 1405, and around a Pentium® III PC under Linux OS running Oracle® 8i as the database machine 1406.

Referring now to FIGS. 15 to 27, there is shown how the user sees the fonctionalities offered by the computer system 1400 of the present invention on the screen of her/his workstation.

When a user wants to create a multimedia sport report to be broadcast on the Internet 1402, using a web browser 1401, she/he utilizes the relevant web site address to access the computer system 1400 offering such a service to display the screen display 1500 represented on FIG. 15.

Clicking on the drop-down list 1501 accesses the list of pre-selected categories of sporting events. Selecting one item displays it in the adjacent text field 1502, where the name of a particular sport can be typed if it does not belong to the list 1501.

Coming to the next field 1503, the operator types the title she/he wants to give to the event. Six other drop-down lists enable the user to enter very easily the current day 1504, month 1505, year 1506, hour 1507, minute 1508 and time area 1509 of the event.

Information on the location of the event is given by means of another drop-down list 1510 for selecting a country, and a text field 1511 to enter a country name.

The content of the HTML page 1500 is transmitted to the computer system 1400 when the user clicks on the “GO” button 1512.

Then the computer system 1400 generates an HTML page according to the value of the sport category field 1502, and sends it to the user's browser 1401. This new page will enable the operator to enter the information which are needed by the computer system 1400 in order to customize automatically the future report.

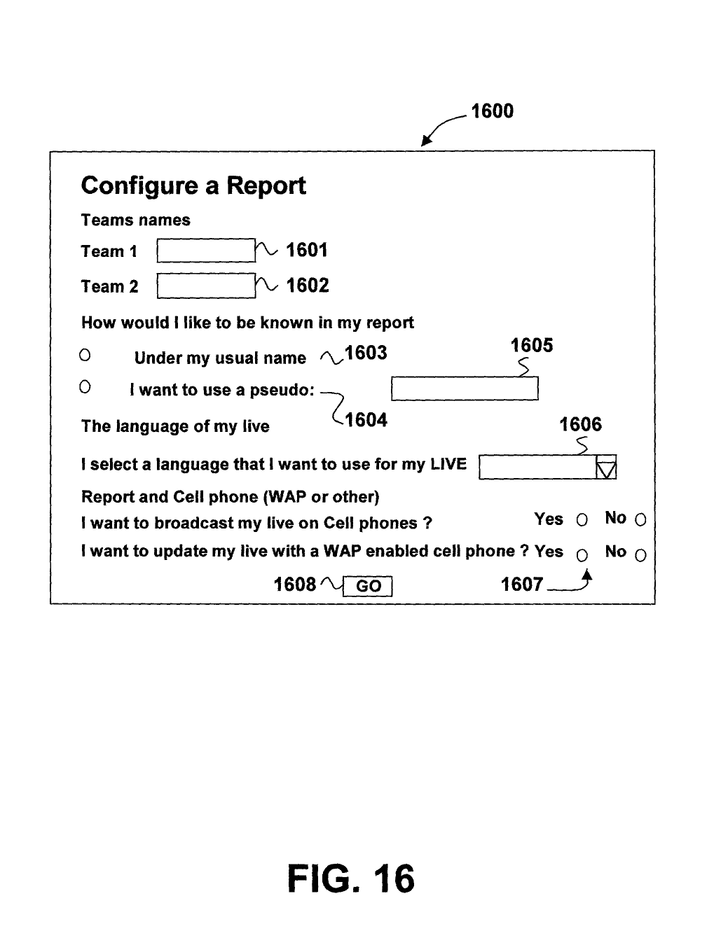

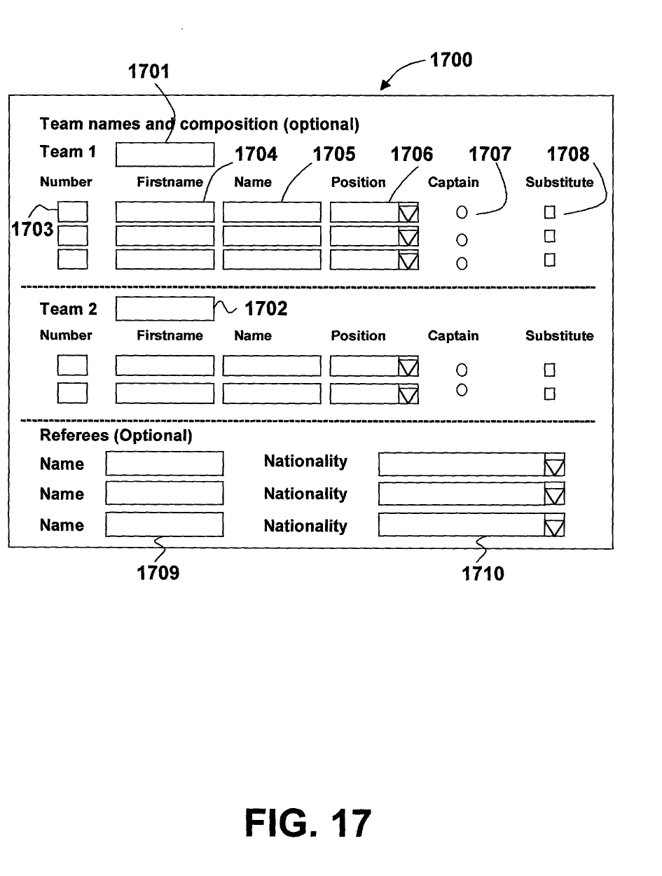

The partial screen captures represented on FIGS. 16 and 17 illustrate this step in the case of soccer games.

The first part 1600 of the HTML page allows entering the names of the two teams in tow separate text fields 1601, 1602. Then the operator can decide either to use her/his usual name as the author name of the report, or to use a pseudo by selecting the corresponding option button 1603, 1604. The pseudo may eventually be entered in the adjacent text field 1605. The language of the report is selected by means of the appropriate drop-down list, among english, french, german or spanish. Any other localization is very easy to implement by the software, due to the structured objets used, as seen above. The four next option buttons 1607 allow the user to decide whether the report will be broadcast on the cell phone network, and if the possibility to update the report by means of a WAP enabled cell phone will be used. All these information are transmitted to the computer system 1400 by clicking on the associated “GO” button 1608.

The second part 1700 of the HTML page is dealing with team names and compositions, and is optional. The names of the teams are already known and are displayed in text fields 1701, 1702 at the top of two arrays, one for each team. Each array features fifteen lines (only a few lines are drawn on FIG. 17), one for each player, which reads from left to right:

a text field to enter the number of the player 1703

a text field to enter player's firstname 1704

a text field to enter player's name 1705

a drop-down list 1706 to enter the position of the player, such as goalkeeper, forward or libero.

an option button 1707 to indicate if the player is the captain

a check box 1708 to indicate if the player is a substitute

This part 1700 of the HTML page to configure a report features also a space to enter information about the referees: text fields 1709 for typing their names, and drop-down lists 1710 to select their nationalities.

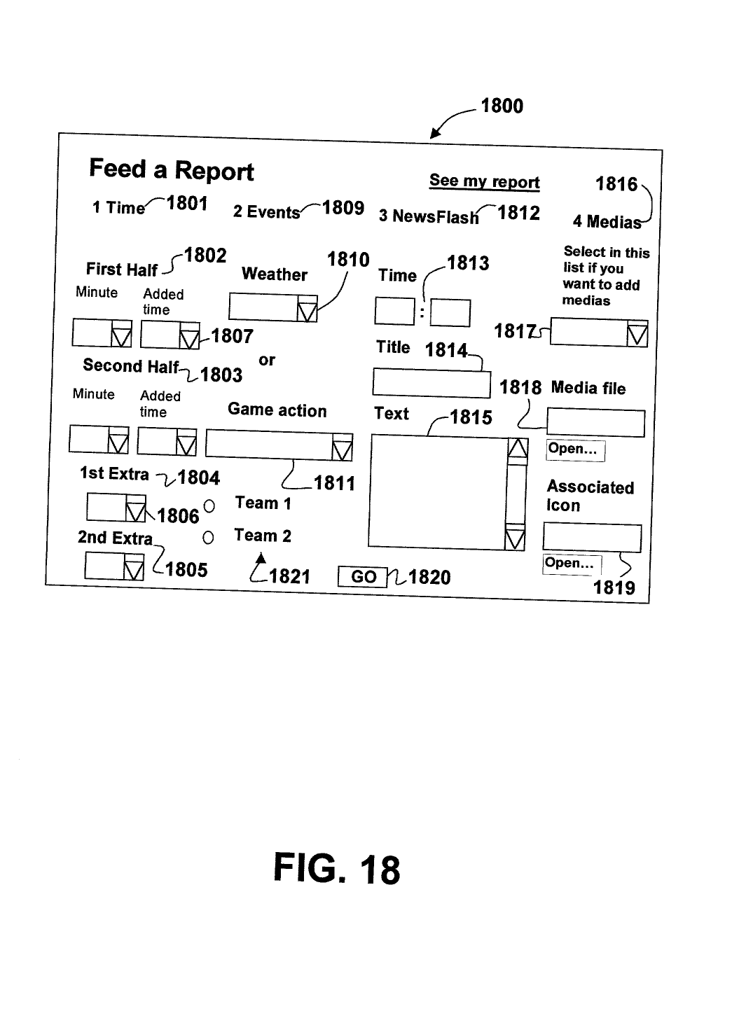

Once the report has been created and configured by the user, it can be updated each time an event happens during the game by means of the HTML page 1800 represented on FIG. 18. This page 1800 comprises four columns, featuring from left to right:

time of the event 1801

The event may have occurred during the first half 1802, the second half 1803, the 1st extra 1804 or the 2nd extra 1805. The number of minutes from the beginning is easily entered by selecting the right value in drop-down lists 1806. Added time is also entered by the same means 1807, 1808.

event 1809

The event may be a change in the weather or a game action. The current weather is selected from the values of a drop-down list 1810, and the particular game action from the values of another drop-down list 1811, i.e. the values of the “key actions” entity 203 stored in the system, like “free kick” or “goal”, already discussed above. The current team is spotted by means of two option buttons 1821.

newsflash 1812

This column comprises two text fields 1813 to enter the current time of the newsflash 1812 in the form hh:mm, another text field 1814 to enter the title of the newsfiash, and a multiline text box for the associated comments.

medias 1816

The last column comprises a drop-down list 1817 for selecting a media type to be associated with the newsflash 1812, such as an “audio” or “video” type, and a file open dialog 1818 for selecting the path of the media file to be uploaded to the computer system 1400. It further comprises another file open dialog 1819 to indicate the path of the associated icon.

All these data entries are then validated and transmitted to the computer system 1400 by clicking on the “GO” button 1820.

It should be pointed out that entering data in the HTML page pictured on FIG. 18 is a very convenient way to update the report each time something happens during the game. No typing is needed if game actions 1811 are simply associated with current time 1801. Updating is in fact so easy that a web browser is not mandatory: a WAP enabled cell phone 402 is sufficient.

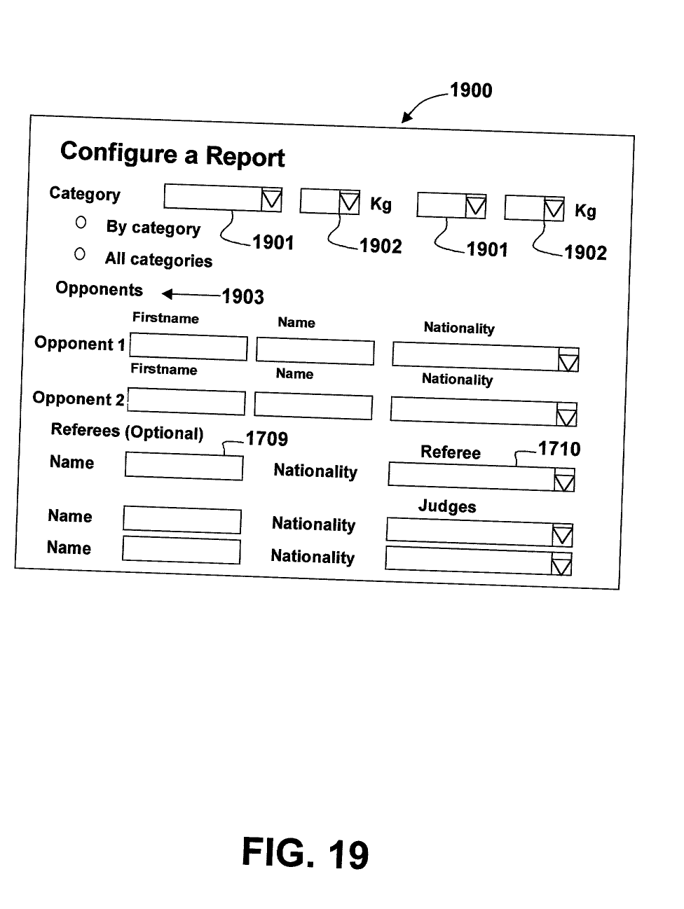

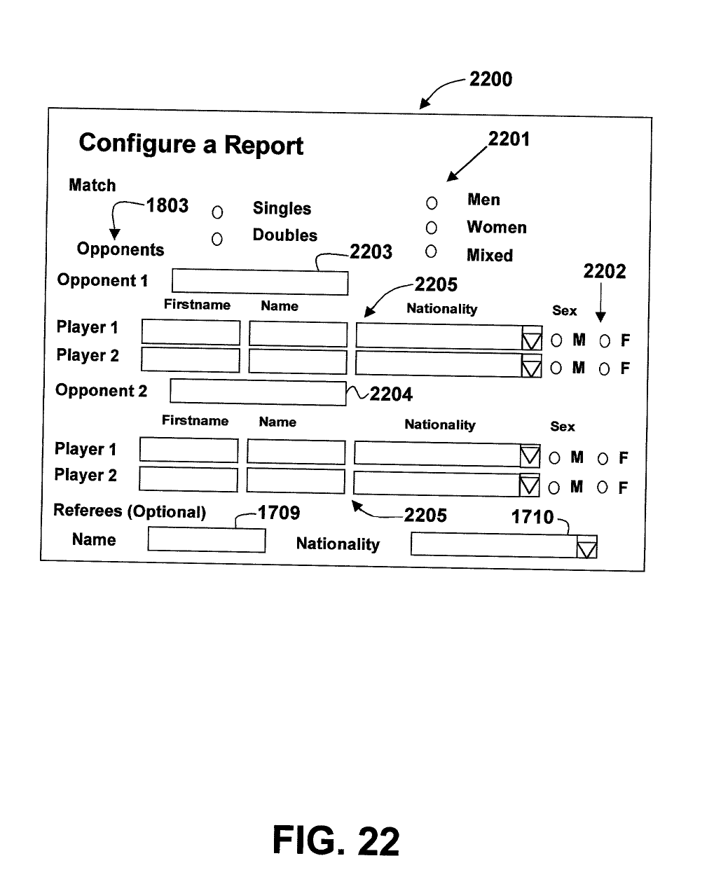

Referring now to FIGS. 19 to 24, there are shown partial screen captures of a user's personal computer to illustrate the way a report can be configured and fed in the cases of judo contests (FIGS. 19 to 21), and tennis matches (FIGS. 22 to 24).

Configuring the report of a judo contest or a tennis match is basically the same operation as configuring a report of a soccer game. Fewer entries are needed as there are only two opponents 1903, instead of two teams, but drop-down lists, option buttons and check boxes are used as much as possible.

In the case of a judo contest (FIG. 19), four drop-down lists help the user in defining the weight category: two with operators like “less than” or “to” 1902, and two with weight ranges in kilos 1902.

In the case of a tennis match (FIG. 22), option buttons indicate the category 2201 (singles, doubles, men, women and mixed), as well as the sexes 2202 of the opponents 1903. The screen display 2200 shows that to one opponent 2203, 2204 may correspond two data lines 2205 for the two players of a men's or ladies' double, for example.

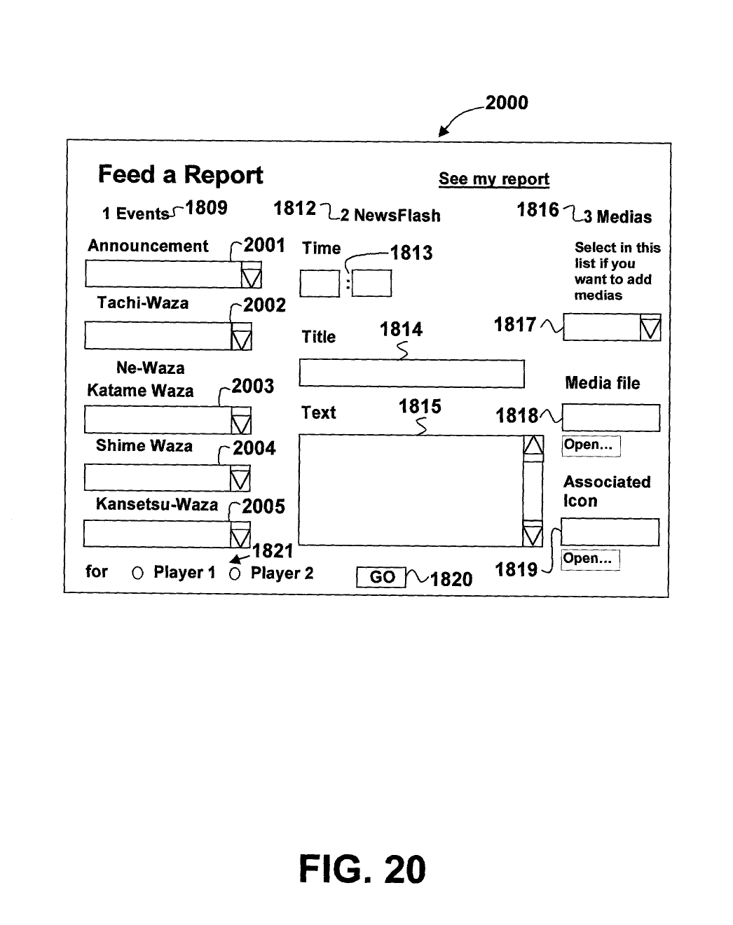

Updating the report of a judo contest or of a tennis match is very similar to feeding a soccer game report. Therefore the same elements are found on the screen captures of FIG. 18 1800 (soccer), FIG. 20 2000 (judo) and FIG. 232300 (tennis).

The main difference between the judo screen (screen capture 2000 of FIG. 20) and the soccer screen (screen capture 1800 of FIG. 18) is that the key actions drop-down lists is divided into five separate drop-down lists according to the category of actions: announcement 2001, Tachi-Waza 2002, Katame-Waza 2003, Shirne-Waza 2004, and Kantsetsu-Waza 2005.

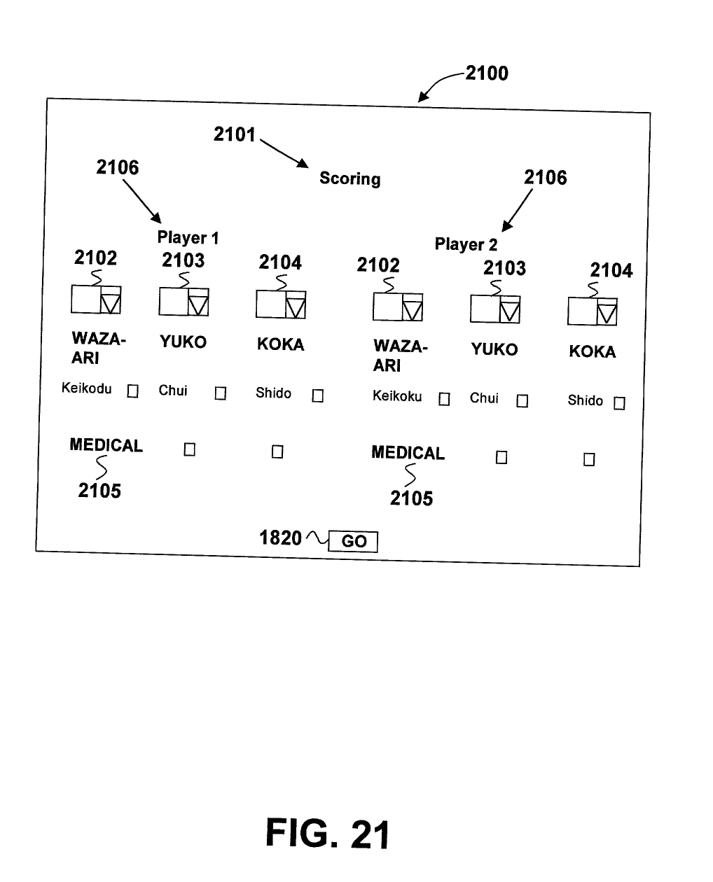

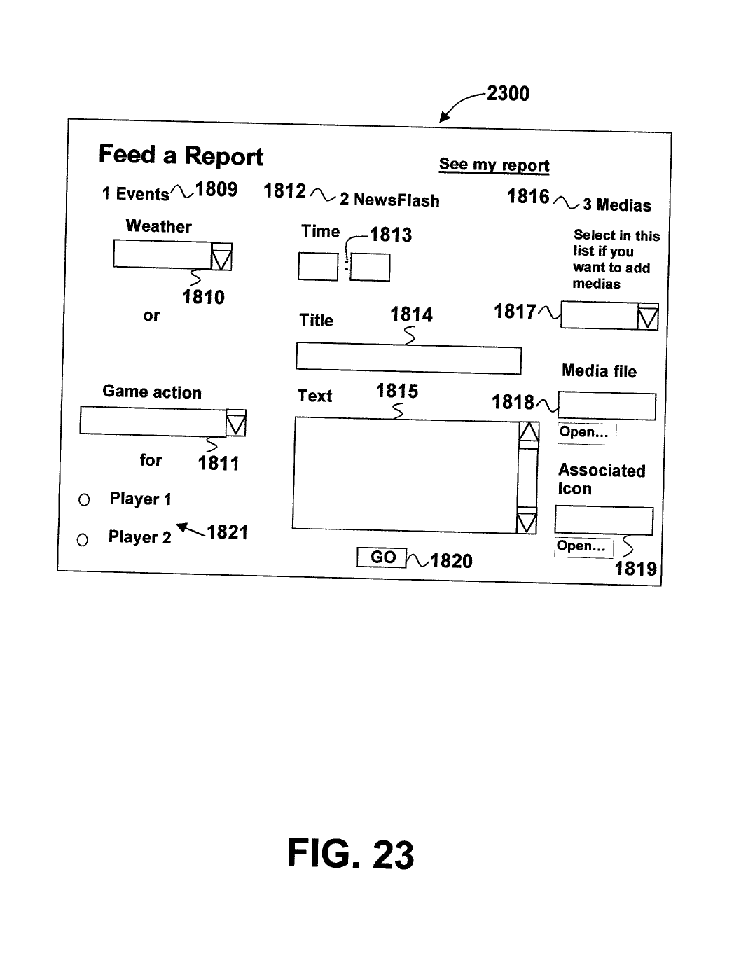

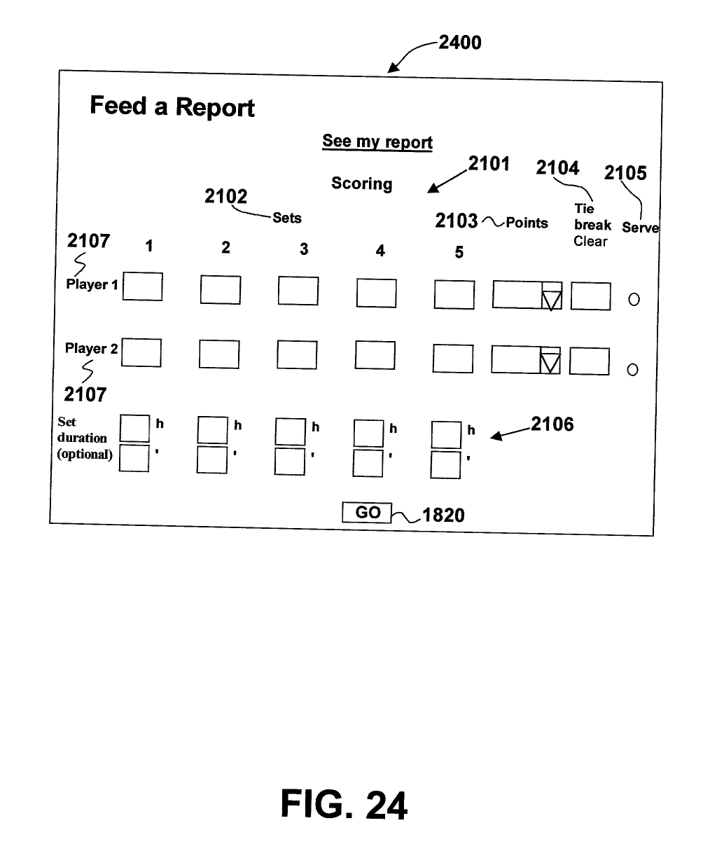

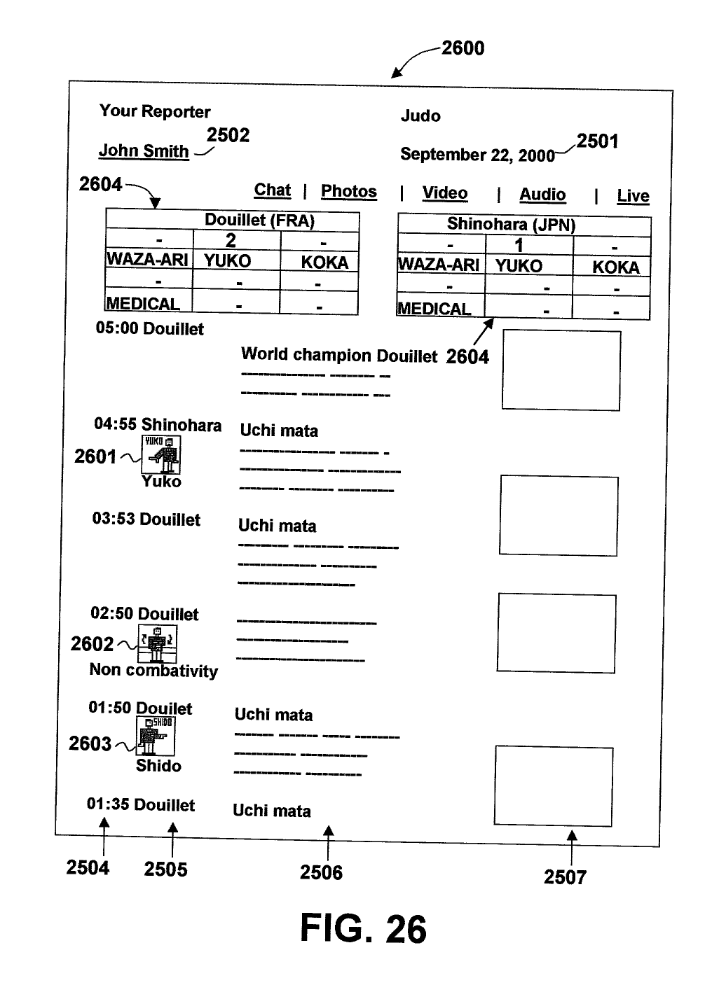

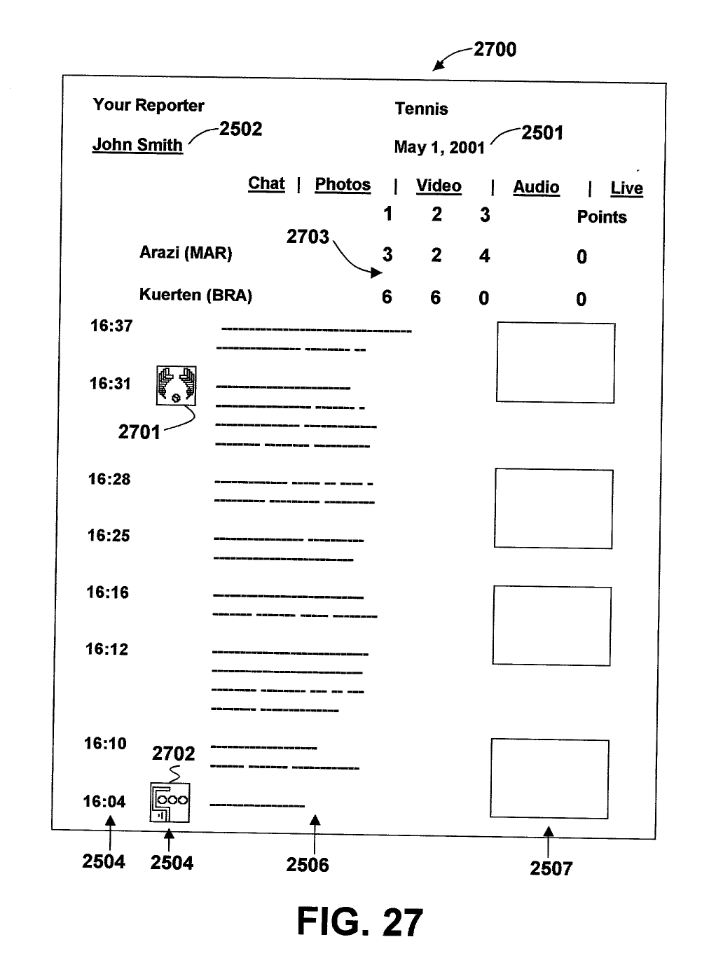

However, scoring is more complex than in the case of a soccer game. To handle this complexity the HTML pages used for updating the judo reports and the tennis reports comprise a scoring part 2101 as shown on the partial screen captures 2100, 2400 represented on FIG. 21, and FIG. 24, respectively. This scoring part 2101 can be used alternatively with the standard entry schemes of FIGS. 20 and 23. It contains information that will appear in the same form on the top of the final report, as it is shown on FIGS. 26 and 27.

In the case of judo, this information is Waza-Ari 2102, Yuko 2103, Koka 2104 and Medical 2105 for each opponent 2106.

In the case of tennis, full information for each player 2107 is given for up to five sets 2102, i.e. points 2103, tie break 2104, service 2105, as well as the set duration 2106.

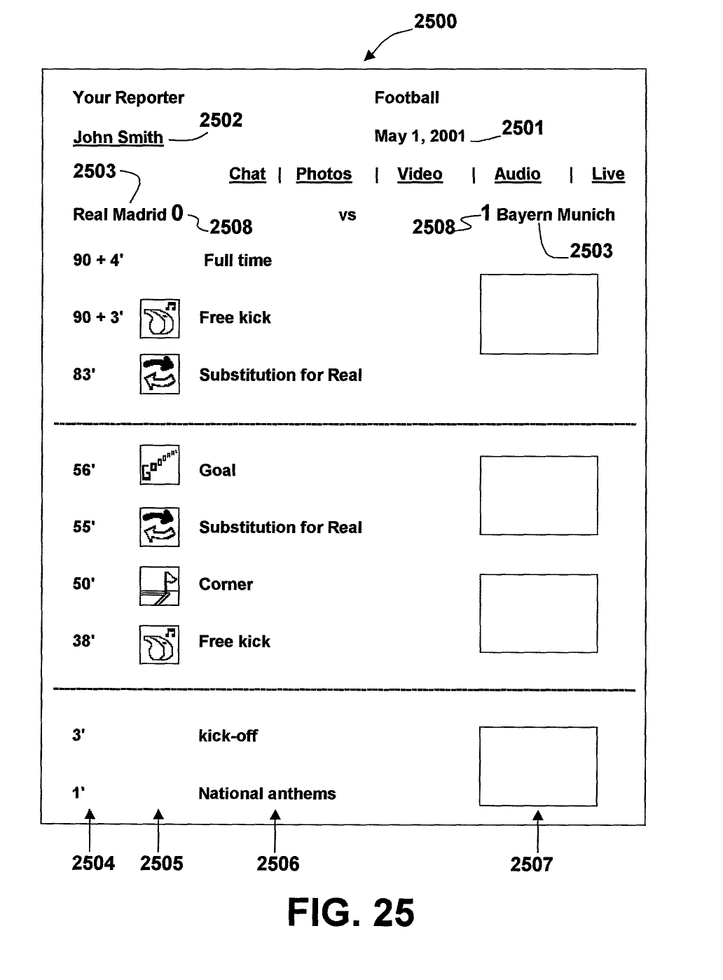

Referring now to FIG. 25, there is shown a partial screen capture 2500 of an example of a soccer report: Real Madrid vs Bayern Munich.

The date 2501 of the event which has been previously entered in the appropriate fields 1504, 1505, 1506 on the creation screen 1500 is found at the top of the page 2500, as well as the name of the reporter 2502.

Next, appear the names 2503 of the teams already typed in the relevant text fields 1601, 1602 of the configuring screen 1600.

The layout of the other textual and pictorial elements of the report 2500 features four columns 2504, 2505, 2506, 2507 each line comprising the information entered by means of the updating screen 1800 and validated by the “GO” button 1820 (only a few lines are shown).

In that example, the first reported event at the bottom of the page 2500 is the national anthems, the last reported event is the end of the game at the top.

In the first column 2504 (from left to right) can be found the elapsed time since the beginning for each event. The information for each period has been entered by means of the time 1801 drop-down lists of the updating screen 1800.

The second column 2505 displays the icons of the pre-determined key actions selected by the “game action” drop-down list 1811. In that example, the icons for free kick, corner, substitution, goal, then again substitution and free kick are shown (from bottom to top).

The third column 2506 contains the titles of the newsflashes entered in the “title” field 1814. If commentaries have been typed in the associated text box 1815, they will be found there, following each title.

The fourth column 2507 displays the pictures illustrating the events, or the icons pointing to media files already uploaded by means of the entries of the right most column 1816 of the updating screen 1800, i.e. an audio file for a spoken commentary.

The current score 2508, calculated after the number of events relating a goal, is displayed on the screen 2500 beside the name 2503 of each team.

Referring now to FIG. 26 and FIG. 27, there are shown a first sample report for a judo contest, Douillet vs Shinohara, and a second one for a tennis match, Arazi vs Kuerten, of the same general layout as the former 2500.

The icons displayed in the second column on the left of the screens 2600, 2700 are of course related to the particular game actions of each sport, such as shido 2603, non combativity 2602, or yuko 2601 for judo, and such as break 2702 or match point 2701 for tennis.

At the top of the pages 2600, 2700 are displayed the scores 2604, 2703, in a way familiar to fans, after the data captured in real-time by means of the previous screens 2000, 2100, 2200, 2300.

While the present invention has been described with reference to a few specific embodiments, the above description is only illustrative of the invention and is not to be construed as limiting the invention. Various modifications may occur to those skilled in the art without departing from the true spirit and scope of the invention as defined by the appended claims.

1) A method for real-time generating, managing, and broadcasting multimedia events reports over communications networks comprising:
a first step of defining a model of said reports having at least an event model with building blocks including a representative set of pre-determined categories of said events, a set of predetermined key actions for each of said pre-determined categories, and a pre-determined time scale of said pre-determined key actions.
a second step of implementing said model on a computer system having at least data input means, data output means, data processing means, data storage means, and data communication means connected to at least a first network of said communications networks using at least a first protocol.
a third step of generating a user report of a current event of particular interest to a user among said events by connecting at least a first client system operated by said user to said computer system via at least said first network, selecting a current category among said pre-determined categories which best fits said current event according to said user's choice, registering an event title, an event date, an event time and an event place as a title, a date, a time and a place of said current event respectively, and associating a first current time of said time scale with a current action selected among said pre-determined key actions occurring during said current event in response to first user inputs by means of the user interface of said first client system.
a fourth step of storing said user report in said data storage means.
a fifth step of broadcasting said user report over at least said first network by means of said data communication means.

2) The method of claim 1 wherein said first step further includes defining a description model of said events with building blocks including a set of pre-determined items for each of said predetermined categories.

3) The method of claim 2 wherein said first step further includes defining a scoring model of said events with building blocks including a set of pre-determined outcomes for each of said pre-determined categories.

4) The method of claim 3 wherein said first step further includes defining a statistics model of said events with building blocks including a set of pre-determined sortings for each of said predetermined categories.

5) The method of claim 1 wherein building blocks of said event model further include a predetermined newsflash type for each of said pre-determined categories, and said third step further includes registering of a current newsflash of the current newsflash type corresponding to said current category associated with a second current time of said time scale in response to second user inputs by means of the user interface of said first client system.

6) The method of claim 5 wherein building blocks of said event model further include a set of pre-determined medias for each of said pre-determined categories, and said third step further includes loading a current media file of the current media type selected among said predetermined medias corresponding to said current category, and associated with said current newsflash, in response to third user inputs by means of the user interface of said first client system.

7) The method of claim 6 wherein said third step further includes loading a current media file icon associated with said current media file in response to fourth user inputs by means of the user interface of said first client system.

8) The method of claim 6 wherein the content of said current media file is a streaming multimedia content.

9) The method of claim 4 wherein said second step includes declaration of the building blocks of said event, description, scoring and statistics models according to the rules of a standard computer language, preferably compliant with XML Schemas standard.

10) The method of claim 1 wherein said first network is a data transport network, preferably the Internet, and said first protocol is preferably TCP/IP (Transport Control Protocol/Internet Protocol).

11) The method of claim 1 wherein said data communication means are connected to at least a second network of said communications networks using at least a second protocol, said second network being preferably a cell phone network and said second protocol being preferably a Wireless Application Protocol (WAP).

12) The method of claim 11 wherein said second network and said second protocol are used by said user to update said user report.

13) The method of claim 11 wherein said second network and said second protocol are used to broadcast said user report.

14) The method of claim 1 wherein said data communication means are connected to at least a third network of said communications networks preferably an interactive television network.

15) The method of claim 14 wherein said third network is used by said user to update said user report.

16) The method of claim 14 wherein said third network is used to broadcast said user report.

17) The method of claim 4 wherein said events are sporting events and the set of said predetermined categories includes basket-ball, bowling, european football or soccer, american football, formula 1, handball, ice hockey, judo, rugby, tennis, volley-ball, and other sports.

18) The method of claim 17 wherein the set of said pre-determined items for each of said predetermined categories includes player, team, referee, category of player, sex, level of competition.

19) The method of claim 17 wherein the set of said pre-determined outcomes for each of said pre-determined categories comprises scores, results, standings.

20) The method of claim 17 wherein the set of said pre-determined sortings for each of said pre-determined categories includes sorting by player, sorting by team, sorting on the event.

21) The method of claim 17 wherein said current category among said pre-determined categories is soccer, said pre-determined time scale comprises first half, second half, first extra, second extra and added time, and the set of said pre-determined key actions includes clearance, corner, direct free kick, end of game, extra time, foul, free kick, goal, goalkeeper, save, hand ball indirect free kick, injury, offside, own goal, penalty, red card, shoot on goal, shoot outside goal, start of the game, stoppage, substitution, touch, yellowcard.

22) The method of claim 1, wherein said third step further includes associating a current action icon selected among a set of pre-determined key action icons with said current action in response to said first user inputs.

23) A system for real-time generating, managing, and broadcasting multimedia events reports over communications networks comprising:
a first network of said communications networks.
a computer system having at least an applications server, a data base management system, and a communications server connected to said first network.
at least a first client system connected to said computer system via at least said first network having at least a graphical user interface and a communication software, display means, pointing means and typing means, wherein said interface includes:
a first drop-down list of pre-determined categories of said events for selecting a current category.
a first entry field for entering an event title.
a second, third and fourth drop-down list of respectively days, months and years for selecting the date of said event.
a fifth, sixth and seventh drop-down list of hours, minutes and time area for selecting the time of said event.
a eighth drop-down list of countries for selecting the country of said event.
a second entry field for entering the city of said event.
a ninth drop-down list of pre-determined key actions for selecting the current action of said event.
a third entry field for entering the current time of said current action.
first command buttons for validating first user entries upon user commands and transferring said first entries to said communications server using said communication software.
said applications server further processing said first and second entries for generating and broadcasting a user report according to data stored in said data base over at least said first network by means of said communications server.

24) The system of claim 23 wherein said interface further includes:
a fourth entry field for entering a title of a newsflash associated with said current time or said current action.
a first multi-line text box for entering a comment associated with said title.
a tenth drop-down list box for selecting a media type associated with said title.
a first file open dialog for selecting a media file of said media type associated with said title.
a second file open dialog for selecting an icon associated with said media file.
second command buttons for validating second user entries upon user commands and transferring said second entries to said computer system using said communication software.

25) The system of claim 23 comprising further a second network of said communications networks, said second network being preferably a cell phone network.

26) The system of claim 25 wherein said interface further includes first option buttons for broadcasting, or not, said user report over said second network.

27) The system of claim 25 wherein said interface further includes second option buttons for updating at least said first and second entries by means of a second client using a Wireless Application Protocol (WAP).

28) The system of claim 24 wherein:
said first network is a network using the TCP/IP protocol, preferably the Internet.
said communications server comprises at least a first HTTP server.
said communication software is an Internet browser.

29) The system of claim 28 wherein said first HTTP server submits the pages received from said browser to said application server further comprising servlets components, preferably according to the Java Server Page™ (JSP) standard, for real-time generating dynamic web pages of said events reports.

30) The system of claim 29 wherein the content of said pages is compliant with a XML description stored in said database.

31) The system of claim 30 wherein said XML description is in XML Schema Description files.

32) The system of claim 28 wherein:
said communications server further comprises at least a second HTTP server.
said computer system further comprises a peer to peer server connected to said first network via said second HTTP server.

33) The system of claim 32 wherein said media file is uploaded or downloaded on said peer to peer server.

34) The system of claim 23, wherein said user report features a plurality of lines, each line comprising said current time and a current action icon automatically associated with said current action.

35) The system of claim 24, wherein said user report features a plurality of paragraphs, each paragraph comprising said current time and said associated newsflash.

36) The system of claim 35, wherein said paragraph further includes said icon associated with said media file or the image of said media file, according to said media type.
